(19) United States
(12) Patent Application Publication
(10) Pub. No.: US 2011/0314744 A1
(43) Pub. Date: Dec. 29, 2011

(54) LOCKING CONTROLLER STRUCTURE OF SLIDING DOOR

(75) Inventor: Jae Hong Choi, Gwangmyeong-si (KR)

(73) Assignee: Hyundai Motor Company, Seoul (KR)

(21) Appl. No.: 12/907,691

(22) Filed: Oct. 19, 2010

(30) Foreign Application Priority Data
Jun. 28, 2010 (KR) 10-2010-0061447

(51) Int. Cl. E05F 15/18

(52) U.S. Cl. 49/359

(57) ABSTRACT

A locking controller mechanism that is capable of opening or closing a sliding door mounted on a vehicle and controlling opening or closing operation of the sliding door through an electrical control unit (ECU), may include an outside lever rotatably mounted about a first pivot shaft and connected to an outside handle that enables the door to be opened or closed on the outside of a vehicle body, a latch release lever rotatably mounted to the first pivot shaft and connected to the outside lever to control latch cables, an inside lever rotatably mounted to the first pivot shaft and connected to the outside lever and an inside handle that enables the door to be opened or closed on the inside of the vehicle body, and a hold open lever rotatably mounted to a second pivot shaft and pivotally connected to the outside lever to be rotatable when the door is closed.

### CROSS-REFERENCE TO RELATED APPLICATION

The present application claims priority to Korean Patent Application No. 10-2010-0061447, filed on Jun. 28, 2010 in the Korean Intellectual Property Office, the entire contents of which is incorporated herein for all purposes by this reference.

### BACKGROUND OF THE INVENTION

1. Field of the Invention

The present invention relates to a locking controller mechanism of a sliding door, and more particularly, to a locking controller mechanism of a sliding door, which can realize reduction of components and manufacturing costs by making it possible to perform a sliding door function with minimum components.

2. Description of the Prior Art

In general, a sliding door provided in a van-type vehicle or the like is adapted to be opened or closed as it slides in forward and backward directions of a vehicle body along a side surface of a vehicle body, and thus has the advantages that a passenger's entrance/exit through the sliding door is facilitated, and an opening/closing of the door is not influenced by the surroundings even in a narrow space.

FIG. 1 is a view illustrating a sliding door in the related art.

According to the sliding door in the related art, if an inside handle 20 is pulled or pushed in a door opening direction in a state where a sliding door 10 is closed, the inside handle 20 that is in a neutral state is shifted in the door opening direction, and thus a door closing keeping mechanism 40 is released by a locking controller mechanism 30.

Also, if the inside handle 20 is pulled or pushed in a door closing direction in a state where the sliding door 10 is opened, the inside handle 20 that is in the neutral state is shifted in a door closing direction, and thus the door closing keeping mechanism 40 is released by the locking controller mechanism 30.

Recently, a sliding door that is automatically opened or closed by manipulation of a switch has been developed and applied to a vehicle provided with a sliding door such as a van type vehicle. This type of sliding door has a structure that is automatically opened or closed using a locking controller, various kinds of link members such as an inside lever, an outside lever, and a control lever, and driving sources such as a motor and a cylinder, and various power transfer means such as cables, belts, or gears. The sliding door is also provided with an ECU (Electrical Control Unit) that controls the operation of the driving sources in association with a door switch.

However, since the sliding door as described above in the related art has been developed based on the structure that is operated by the manipulation of a manual handle, it is not suitable to simply apply the automatic sliding door by the switch manipulation to the structure. Also, since many kinds of link members such as the control lever and the like are used, the number of components is increased and the manufacturing cost is heightened.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a locking controller mechanism of a sliding door, which can realize reduction of components and manufacturing costs by making it possible to perform a sliding door function particularly with minimum components.

In order to accomplish this subject, there is provided a locking controller mechanism that is capable of opening or closing a sliding door mounted on a vehicle and controlling opening or closing operation of the sliding door through an electrical control unit (ECU), wherein the locking controller mechanism may include an outside lever rotatably mounted about a first pivot shaft and connected to an outside handle that enables the door to be opened or closed on the outside of a vehicle body, a latch release lever rotatably mounted to the first pivot shaft and connected to the outside lever to control latch cables, an inside lever rotatably mounted to the first pivot shaft and connected to the outside lever and an inside handle that enables the door to be opened or closed on the inside of the vehicle body, and a hold open lever rotatably mounted to a second pivot shaft and pivotally connected to the outside lever to be rotatable when the door is closed.

The locking controller mechanism may further include a front latch connected to the locking controller mechanism to maintain or release a closed state of the door.

An outside lever sensor may be mounted near to the outside lever and a hold open sensor is mounted near to the hold open lever to generate corresponding signals, wherein signals of the outside lever sensor and the hold open sensor are transferred to the ECU in accordance with the rotation of the outside lever and the hold open lever, and the ECU controls the sliding door in accordance with the signals of the outside lever sensor and the hold open sensor.

With the above-described construction, the locking controller mechanism of a sliding door according to the present invention can reduce components and manufacturing costs through reduction of additional link members for the sliding door and improve the productivity through reduction of the weight of the components.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a sectional view illustrating a sliding door in the related art.

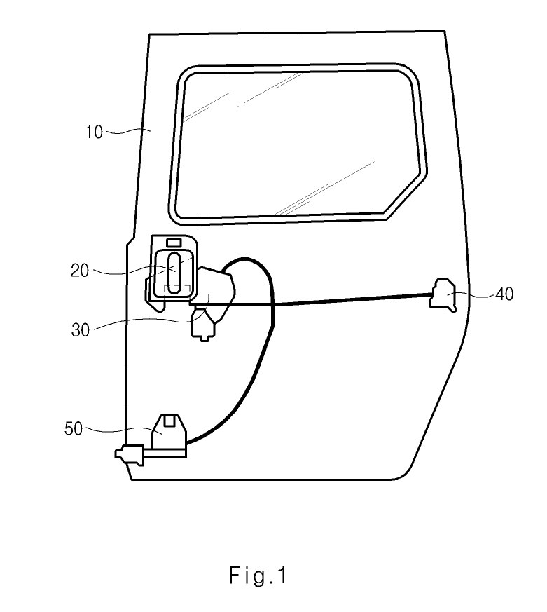

FIG. 2 is a view illustrating a locking controller mechanism in a locking controller mechanism of a sliding door according to an exemplary embodiment of the present invention.

FIG. 3 is a view illustrating a locking controller mechanism and a front latch in a locking controller mechanism of a sliding door according to an exemplary embodiment of the present invention.

FIG. 4 is a view explaining the operation relationship of an outside lever when a sliding door is opened or closed in a locking controller mechanism of the sliding door according to an exemplary embodiment of the present invention.

FIG. 5 is a view explaining the operation relationship of an inside lever when a sliding door is opened or closed in a locking controller mechanism of the sliding door according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

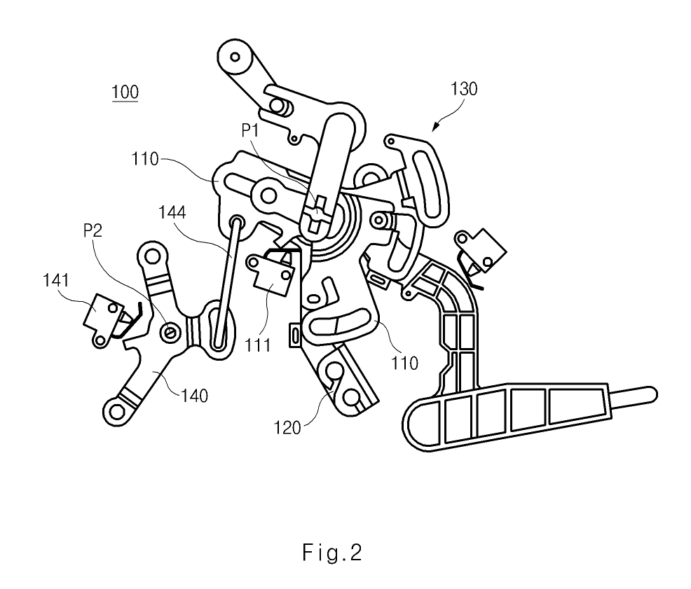

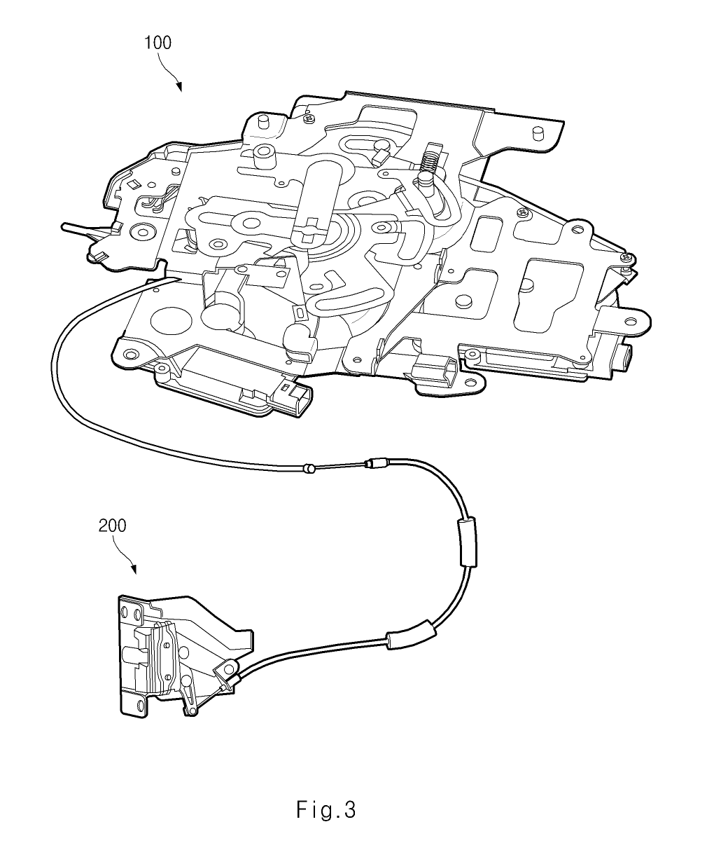

FIGS. 2 to 5 show a locking controller mechanism of a sliding door according to an exemplary embodiment of the present invention. FIG. 2 is a view illustrating a locking controller mechanism in a locking controller mechanism of a sliding door according to an exemplary embodiment of the present invention, and FIG. 3 is a view illustrating a locking controller mechanism and a front latch in a locking controller mechanism of a sliding door according to an exemplary embodiment of the present invention.

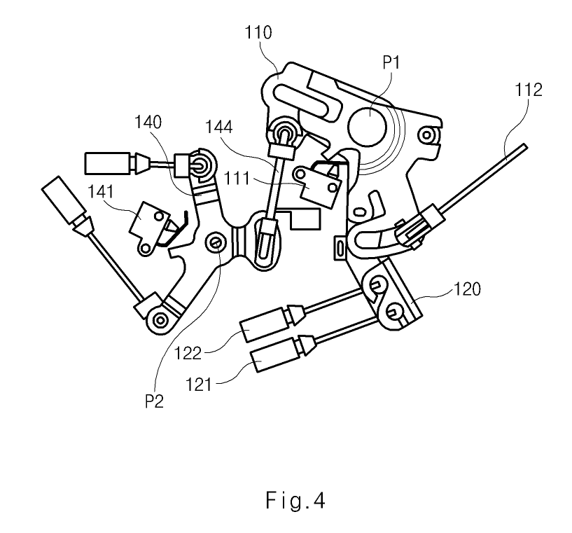

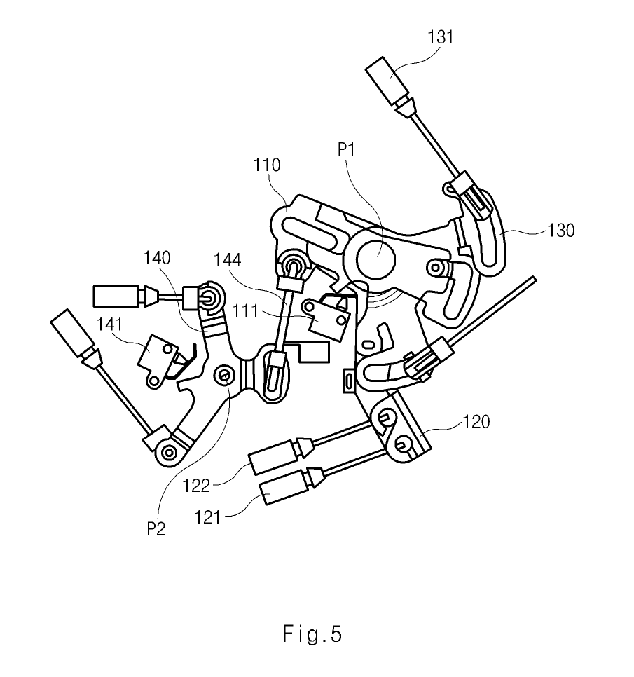

Also, FIG. 4 is a view explaining the operation relationship of an outside lever when a sliding door is opened or closed in a locking controller mechanism of the sliding door according to an exemplary embodiment of the present invention, and FIG. 5 is a view explaining the operation relationship of an inside lever when a sliding door is opened or closed in a locking controller mechanism of the sliding door according to an exemplary embodiment of the present invention.

The locking controller mechanism of a sliding door according to an exemplary embodiment of the present invention, as illustrated in FIGS. 2 to 5, including a locking controller mechanism of the sliding door, capable of opening or closing the sliding door mounted on a vehicle and controlling an opening or closing operation of the sliding door through an electrical control unit (ECU), wherein the locking controller mechanism 100 includes an outside lever 110 connected to an outside handle that enables the door to be opened or closed on the outside of a vehicle body, a latch release lever 120 rotatably mounted by the outside lever 110, an inside lever 130 connected to an inside handle that enables the door to be opened or closed on the inside of the vehicle body, and a hold open lever 140 connected to the outside lever 110. The basic technical feature of the locking controller mechanism is to reduce the manufacturing cost through minimization of link members for the sliding door and to improve the productivity through reduction of the weight.

The respective constituent elements of the locking controller mechanism of the sliding door according to an exemplary embodiment of the present invention will be described one by one with reference to the accompanying drawings.

As illustrated in FIG. 2, the locking controller mechanism 100 includes the outside lever 110, the latch release lever 120, the inside lever 130, and the hold open lever 140.

The locking controller mechanism 100 is installed in a housing mounted on the inside of the sliding door, and includes a plurality of links and cables to transfer and control a manipulation force of the handle. In particular, the locking controller mechanism can open or close the sliding door through movement of the cables by the link operation.

More specifically, the locking controller mechanism 100 includes the outside lever 110 that is rotated about a first pivot shaft P1 mounted in the housing and the inside lever 130.

Here, the outside lever 110 is rotatably mounted about the first pivot shaft P1, and is inserted into the inside of the sliding door in a state where it is connected to the outside handle provided on the outside of a vehicle body. Accordingly, it is possible for a user to open or close the sliding door on the outside of the vehicle body.

In this case, an outside lever sensor 111 is mounted near to the outside lever 110, and operates to generate an on/off signal when the outside lever 110 is rotated.

The latch release lever 120 is rotatably mounted about the first pivot shaft P1 together with the outside lever 110, and controls a front latch cable 121 (see FIGS. 4 and 5) and a rear latch cable 122 (see FIGS. 4 and 5).

The inside lever 130 is rotatably mounted about the first pivot shaft P1, and is inserted into the inside of the sliding door in a state where it is connected to the inside handle provided on the inside of the vehicle body. Accordingly, it is possible for a user to open or close the sliding door on the inside of the vehicle body.

The hold open lever 140 is rotatably mounted about a second pivot shaft P2, and is connected to the outside lever 110 by a link 144 to be rotatable when the door is closed by the outside lever 110.

In this case, a hold open sensor 141 is mounted near to the hold open lever 140 which is rotated when the outside lever 110 is rotated, and operates to generate an on/off signal when the outside lever 110 is rotated.

As illustrated in FIGS. 2 and 3, a front latch 200 is connected to the locking controller mechanism 100 to maintain or release the closed state of the sliding door. More specifically, as illustrated in FIGS. 4 and 5, the front latch 200 is connected to the latch release lever 120 through the cable , and when the latch release lever 120 controls the front latch cable 121, it controls the closed state of the sliding door.

On the other hand, the on/off signals generated by the outside lever sensor 111 and the hold open sensor 141 in accordance with the rotation of the outside lever 110 and the hold open lever 140 are transferred to the ECU . The signals of the outside lever sensor 111 and the hold open sensor 141 control the sliding door through the ECU.

As described above, through the inside handle and the outside handle mounted on the inside and the outside of the vehicle body, the outside lever 110, the latch release lever 120, the inside lever 130, the hold open lever 140 of the locking controller mechanism 100 are operated, and the opening and closing operation of the sliding door by the locking controller mechanism 100 is controlled by the ECU through the outside lever sensor 111 and the hold open sensor 141.

Hereinafter, the operation and effect of the present invention will be described.

FIG. 4 is a view explaining the operation of a locking controller mechanism related to an outside handle when a sliding door is opened or closed in a locking controller mechanism of the sliding door according to an exemplary embodiment of the present invention.

In the case of opening the door, if the outside handle mounted on the outside of the vehicle body is pulled, an outside handle cable 112 connected to the outside handle is pulled, and thus the outside lever 110 and the latch release lever 120 are rotated about the first pivot shaft P1. Accordingly, the front latch cable 121 and the rear latch cable 122 are simultaneously pulled to release the latch.

In this case, if the outside lever 110 is rotated, the hold open lever 140 is also rotated about the second pivot shaft P2 by the link 144 coupled to the outside lever 110, and the outside lever sensor 111 and the hold open sensor 141 are turned on. At this time, signals of the outside lever sensor 111 and the hold open sensor 141 are transferred through the ECU , and the latch is released to control the sliding door.

In the case of closing the door, if the outside handle mounted on the outside of the vehicle body is pulled, the outside handle cable 112 connected to the outside handle is pulled, and thus the outside lever 110 and the hold open lever 140 are rotated about the first pivot shaft P1 and the second pivot shaft P2, respectively. Accordingly, the cables, which are connected to the outside lever 110 and the hold open lever 140, are simultaneously pulled to release the latch.

In this case, if the outside lever 110 is rotated, the hold open lever 140 is also rotated about the second pivot shaft P2, and the outside lever sensor 111 and the hold open sensor 141 are turned on. At this time, signals of the outside lever sensor 111 and the hold open sensor 141 are transferred through the ECU , and the latch is engaged to control the sliding door.

FIG. 5 is a view illustrating the operation relationship of the locking controller mechanism related to an inside handle when the sliding door is opened or closed.

In the case of opening the door, if the inside handle mounted on the inside of the vehicle body is pulled, an inside handle cable 131 connected to the inside handle is pulled, and thus the inside lever 130 and the outside lever 110 are rotated about the first pivot shaft P1. Accordingly, the front latch cable 121 and the rear latch cable 122 are simultaneously pulled to release the latch.

In this case, if the outside lever 110 is rotated, the hold open lever 140 is also rotated about the second pivot shaft P2, and the outside lever sensor 111 and the hold open sensor 141 are turned on. At this time, signals of the outside lever sensor 111 and the hold open sensor 141 are transferred through the ECU , and the latch is released to control the sliding door.

In the case of closing the door, if the inside handle mounted on the inside of the vehicle body is pulled, the inside handle cable 131 connected to the inside handle is pulled, and thus the inside lever 130 and the hold open lever 140 are rotated about the first pivot shaft P1 and the second pivot shaft P2, respectively. Accordingly, the cables, which are connected to the inside lever 130 and the hold open lever 140, are simultaneously pulled to release the latch.

In this case, if the inside lever 130 is rotated, the hold open lever 140 is independently rotated, and also the hold open sensor 141 is independently is turned on. At this time, a signal of the hold open sensor 141 is transferred through the ECU , and the latch is released to control the sliding door.

The locking controller mechanism of the sliding door as constructed above according to an exemplary embodiment of the present invention includes the outside lever, the latch release lever, the inside lever, and the hold open lever. Thus, the locking controller mechanism of the sliding door according to an exemplary embodiment of the present invention can reduce components and manufacturing costs through the reduction of additional link members for the sliding door and improve the productivity through the reduction of the weight of the components.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A locking controller mechanism that is capable of opening or closing a sliding door mounted on a vehicle and controlling opening or closing operation of the sliding door through an electrical control unit (ECU), wherein the locking controller mechanism comprises:
an outside lever rotatably mounted about a first pivot shaft and connected to an outside handle that enables the door to be opened or closed on the outside of a vehicle body;
a latch release lever rotatably mounted to the first pivot shaft and connected to the outside lever to control latch cables;
an inside lever rotatably mounted to the first pivot shaft and connected to the outside lever and an inside handle that enables the door to be opened or closed on the inside of the vehicle body; and
a hold open lever rotatably mounted to a second pivot shaft and pivotally connected to the outside lever to be rotatable when the door is closed.

2. The locking controller mechanism as claimed in claim 1, further comprising a front latch connected to the locking controller mechanism to maintain or release a closed state of the door.

3. The locking controller mechanism as claimed in claim 1, wherein an outside lever sensor is mounted near to the outside lever and a hold open sensor is mounted near to the hold open lever to generate corresponding signals.

4. The locking controller mechanism as claimed in claim 3, wherein signals of the outside lever sensor and the hold open sensor are transferred to the ECU in accordance with the rotation of the outside lever and the hold open lever, and the ECU controls the sliding door in accordance with the signals of the outside lever sensor and the hold open sensor.
